(19) United States
(12) Patent Application Publication
(10) Pub. No.: US 2016/0206508 A1
(43) Pub. Date: Jul. 21, 2016

(54) CONTAINER COVERED WITH A PROTECTION AND RETENTION COATING, A KIT FOR MANUFACTURING A PROTECTION AND RETENTION COATING, AND A RELATED MANUFACTURING METHOD

(71) Applicant: SGD S.A., Puteaux (FR)

(72) Inventor: Carine Perrot, Etalondes (FR)

(21) Appl. No.: 14/995,731

(22) Filed: Jan. 14, 2016

(30) Foreign Application Priority Data
Jan. 15, 2015 (FR) 1550325

(51) Int. Cl. A61J 1/14; C09D 175/04; B65D 23/02

(52) U.S. Cl. CPC A61J 1/1468; B65D 23/02; C09D 175/04

(57) ABSTRACT

A container covered with a protection and retention coating, a kit for manufacturing a protection and retention coating, and a related manufacturing. The invention provides a container (1) comprising a glass wall (2) defining a reception cavity (3) for receiving a fluid substance, said container (1) further comprising a protection and retention coating (5) that covers the outside of said glass wall (2), said container (1) being characterized in that said protection and retention coating (5) is a multilayer coating that is transparent and that comprises a bottom layer (5A) that covers the glass wall (2), and a top layer (5B) that covers said bottom layer (5A), said bottom layer (5A) being made up of a polyurethane-based material, while said top layer (5B) is made up of a polyurethane-based material that is functionalized by a fluoropolymer-based compound.

### CROSS-REFERENCE TO RELATED APPLICATIONS

This application claims the priority of French Patent Application No. 1550325, filed Jan. 15, 2015, which is hereby incorporated by reference in its entirety into this application.

### BRIEF SUMMARY OF THE INVENTION

The present invention relates to the general field of hollow bodies, and more precisely containers of the bottle type, that are provided with a glass surface and that are suitable for use in various industrial sectors, in particular in the sector of packaging substances in liquid, paste, or spray form, e.g. pharmaceutical, cosmetic, or food substances. The invention also relates to the technical field of treating glass containers for functional and/or decorative purposes, in particular in the pharmaceutical, cosmetic, or food sectors.

### BRIEF DESCRIPTION OF THE SEVERAL VIEWS OF THE DRAWING

FIG. 1. A diagrammatic section view of a container of the invention, which is constituted specifically by a bottle for receiving a liquid pharmaceutical composition and being closed by a cap.

### DETAILED DESCRIPTION OF THE INVENTION

The invention relates more precisely to a container comprising a glass wall that defines a reception cavity for receiving a fluid substance, said container further comprising a protection and retention coating that covers at least a fraction of the outside of said glass wall.

The invention also relates to a kit for manufacturing a protection and retention coating for covering at least a fraction of the outside of a glass wall of a container.

Finally, the invention relates to a method of manufacturing a container, in which method a glass wall defining a reception cavity for receiving a fluid substance is manufactured or provided, said method including a step of covering at least a fraction of the outside of said glass wall with a protection and retention coating.

It is known to use glass containers for containing liquid compositions, in particular in the pharmaceutical sector, but also in other sectors (the cosmetic, and in particular the perfumery, sector, the food sector, etc.). Specifically, glass turns out to be a material that is particularly suitable for storing compositions for pharmaceutical use or for veterinary use as a result of its relatively neutral nature that makes it possible to avoid or to limit interactions with the composition contained in the container, of its robustness, of its transparency (that makes it possible to check the contents visually), and of its mechanical and chemical stability. These various qualities are also sought in sectors other than the pharmaceutical sector, e.g. in the food field, or in the cosmetic field in which the use of glass for making fragrance bottles is particularly prized, given that customers generally hold glass in high esteem, and also given the above-mentioned qualities of transparency, robustness, and stability of this material.

Nevertheless, glass presents drawbacks that can result in particularly damaging consequences.

Thus, one of the major drawbacks of glass is its brittle nature. In the event of impact, e.g. as a result of dropping the container (which may consist of a bottle containing medicine for infusing or injecting, for example), the glass can easily break into multiple pieces of various size that fly in all directions and that may be sharp or pointed, with all of the risks that that presents for the personnel in charge of handling the bottle under consideration (e.g. hospital personnel), and people who are in the proximity of the container when it breaks (e.g. patients). Thus, in the event of a glass container breaking, it is necessary to clean up particularly carefully and thoroughly so as to be sure that all the broken glass is removed, even fragments of small size, which might injure a person walking over them or ingesting them by accident. Furthermore, when a glass container breaks, the liquid composition that it contains spills out suddenly, generally splashing and spattering over a wide area. This results not only in the need to clean up, but also, and above all, this may result in a risk to the health and safety of people nearby (hospital personnel, patients) when the composition contained in the glass bottle is a dangerous composition, such as a cytotoxic drug.

In order to remedy this problem, it has been proposed to fit pharmaceutical glass bottles containing a cytotoxic composition with protective outer packaging made of rigid plastics material (polypropylene). Such outer packaging is for protecting against impacts to which the bottles might be subjected, in particular while being transported), and also enables users to avoid making any contact with the glass surface of the bottles while handling them, which surfaces might have been polluted by the cytotoxic substance contained in the bottles while said bottles were being filled. The outer packaging may be attached to the bottle by various means, e.g. by means of small strips made of plastics material, or by means of a ring having fins that is fastened below the neck of the bottle.

The use of such outer packaging does indeed make it possible to improve safety in use, but said safety in use is nevertheless far from being good.

Thus, as a result of its relatively rigid nature, the plastics-material outer packaging does not provide good shock-absorption and may itself break. Furthermore, if the bottle shatters, not only does the outer packaging fail to retain the liquid contained in the bottle, it is also possible it will not retain the broken glass.

Glass laboratory containers are also known that are covered with a polyurethane film for improving their ability to withstand impacts. However, the film presents flexibility that is relatively limited, such that its effectiveness with regard to its ability to withstand impacts is not as good as it could be. Also, the film does not make it possible to guarantee that the broken glass and the liquid contained in the container can be retained effectively if the container breaks (even though that is acceptable in this situation since it relates to a laboratory container and not to a container for containing a pharmaceutical composition, and in particular a cytotoxic composition). The film in question also presents a “frosted” texture with a surface state that is slightly rough, and that could encourage potential contaminants to be retained on its surface, it also being understood that such a texture is not good for the purpose of sterilization, in particular in an autoclave.

Consequently, the objects assigned to the invention seek to remedy the drawbacks set out above, and to propose a novel container comprising a glass wall that, while being sterilizable, including by methods that induce high thermo-mechanical stresses, is also particularly able to withstand impacts, and makes it possible to retain any broken glass and the contents of the container effectively, in the event of said container being broken.

Another object of the invention seeks to propose a novel container comprising a glass wall that is provided with a protection and retention coating that is particularly discreet and effective.

Another object of the invention seeks to propose a novel container provided with a glass wall that, while presenting good properties of retention and of resistance to impacts, can be manufactured easily, quickly, and safely.

Another object of the invention seeks to propose a novel container provided with a glass wall that, while presenting good properties of retention and of resistance to impacts, lends itself particularly well to sterilization operations, in particular in an autoclave.

Another object of the invention seeks to propose a novel kit for manufacturing a protection and retention coating, which kit is of design that is simple and inexpensive, and that can be used particularly easily, quickly, and safely.

Another object of the invention seeks to propose a novel manufacturing method that makes it possible to obtain, in simple, quick, and safe manner, a container with a glass wall that is particularly able to withstand impacts, and that presents good properties of retention.

Another object of the invention seeks to propose a novel method of manufacturing a container with a glass wall, which method can be implemented while requiring only simple and standard industrial means.

The objects assigned to the invention are achieved by means of a container comprising a glass wall that defines a reception cavity for receiving a fluid substance, said container further comprising a protection and retention coating that covers at least a fraction of the outside of said glass wall, said container being characterized in that said protection and retention coating is a multilayer coating that is substantially transparent and that comprises a bottom layer that covers the glass wall, and a top layer that covers said bottom layer, said bottom layer being made up of a polyurethane-based flexible material that bonds to said glass wall, while said top layer is made up of a polyurethane-based material that is functionalized by a fluoropolymer-based compound.

The objects assigned to the invention are also achieved by means of a kit for manufacturing a multilayer protection and retention coating that is substantially transparent and that is for covering at least a fraction of the outside of a glass wall of a container, said glass wall defining a reception cavity for receiving a fluid substance, said kit comprising:

a first intermediate composition for applying in the form of a first layer to the glass wall, said first intermediate composition consisting of a dispersion of a non-reactive polyurethane in an aqueous phase, the molecular mass of said non-reactive polyurethane being high enough for mere evaporation of the aqueous phase to cause a flexible film that bonds to the glass wall to be formed from said first layer; and

a second intermediate composition in an aqueous phase for applying in the form of a second layer covering said first layer, said second intermediate composition in an aqueous phase including at least one isocyanate and at least one fluoropolymer-based substance for reacting together after applying said second intermediate composition to said first layer, so as to form a polyurethane-based material that is functionalized by a fluoropolymer-based compound.

Finally, the objects assigned to the invention are also achieved by means of a method of manufacturing a container, in which method a glass wall defining a reception cavity for receiving a fluid substance is manufactured or provided, said method including a step of covering at least a fraction of the outside of said glass wall with a protection and retention coating, said method being characterized in that said protection and retention coating is a multilayer coating that is substantially transparent and that comprises a bottom layer that covers the glass wall, and a top layer that covers said bottom layer, said bottom layer being made up of a polyurethane-based flexible material that bonds to said glass wall, while said top layer is made up of a polyurethane-based material that is functionalized by a fluoropolymer-based compound.

Other objects and advantages of the invention appear better on reading the following description, and from the accompanying drawing, which is given purely by way of non-limiting illustration, and which shows, in a diagrammatic section view, an embodiment of a container of the invention, which container is constituted specifically by a bottle for receiving a liquid pharmaceutical composition, said bottle specifically being closed by a cap.

In a first aspect, the invention provides a container 1 comprising a glass wall 2 that defines a reception cavity 3 for receiving a fluid substance, i.e. a substance that can flow, e.g. a liquid, a paste (such as a liquid with a high degree of viscosity), or a powder. Preferably, the container 1 forms a container that is designed to contain a pharmaceutical liquid substance, e.g. a medicine, and in particular a cytotoxic drug, possibly for intravenous or intramuscular injection, or for administering by infusion, or for ingestion by a patient.

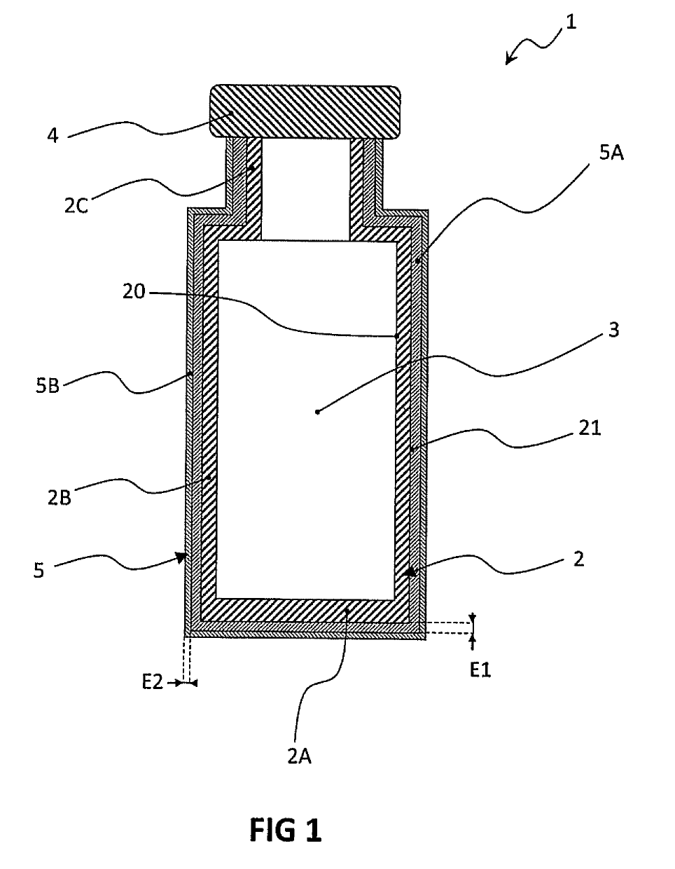

Even though the application to the pharmaceutical field is preferred, the invention is however not limited to containers for pharmaceutical use, and, by way of alternative variant, also relates to a container 1 that is designed to contain a liquid substance for veterinary use, or a liquid substance for food use, or a liquid substance for cosmetic use (body fragrance, cream, or other cosmetic). In general, the container 1 is thus advantageously for containing, in its reception cavity 3, a substance for administering to a human being or to an animal. The container 1 may thus be of any shape that is suitable for its function, and, by way of example and as shown in FIG. 1, it may be in the shape of a bottle, e.g. for containing a liquid composition for pharmaceutical use. In this configuration, the glass wall 2 is advantageously made up of a glass bottom wall 2A, a glass side wall 2B that extends upwards from the periphery of the bottom wall 2A, and a neck 2C that terminates the bottle, while forming a filling and dispensing opening that makes it possible to put the cavity 3 into communication with the outside. Said opening is possibly closed by a removable cap 4, as shown in FIG. 1. However, it is entirely possible for the container 1 to have an entirely different shape, and in particular a shape that does not have a neck, e.g. a tube, an ampule, a syringe, or some other shape, depending on its intended use. Such a glass container, and in particular in the form of a bottle, may be obtained by any conventional glass making method (molded glass, drawn glass, Vello process, or Danner process, etc.).

Preferably, the glass wall 2 of the container 1 defining the reception cavity 3 is in the form of a single piece that simultaneously forms the bottom wall 2A, the side wall 2B, and the neck 2C, such that the reception cavity 3 is advantageously defined entirely by a single piece that is made of glass, except for the cap 4, if any. However, it is entirely possible for only a portion of the container 1 (e.g. only the side wall 2B) to be made of glass. More precisely, and as shown in FIG. 1, the glass wall 2 presents an inside face 20 that is situated facing the reception cavity 3, and an opposite outside face 21. Advantageously, the glass wall 2 thus forms a hollow and empty body having an inside face 20 that directly defines the cavity 3, which cavity forms an empty internal volume that is entirely closed, except for the opening towards the outside formed in the neck 2C having a section that, in this configuration, is small relative to the average section of the cavity 3 (FIG. 1).

The term “glass” should be understood in its conventional sense, and thus designates a mineral glass, and preferably a silica glass. By way of example, the glass constituting the wall 2 is a transparent colorless glass, such as soda-lime glass or borosilicate glass. The glass used to make the wall 2 is preferably colorless, but may alternatively be colored, e.g. by metal oxides, so as to protect the fluid substance contained within the container 1 from the effects of light, in particular in certain wavelength ranges.

The container 1 further comprises a protection and retention coating 5 that covers at least a fraction, and preferably substantially all, of the outside of the glass wall 2. In the advantageous embodiment shown in the figure, the coating 5 thus covers, substantially continuously and uniformly, the entire outside face 21, i.e. the bottom wall 2A, the side wall 2B, and the neck 2C, such that the bottle shown in FIG. 1 is entirely coated on its outside face 21, which is thus practically inaccessible from the outside.

The protection and retention coating 5 seeks to provide various functions, and in particular the following functions:

a protection function for protecting against impacts, so as to increase the ability of the container 1 to withstand impacts, the coating 5 acting, to this end, as a shock-absorbing protective sheath for “shatter-proofing”; and

a retention function in the event of the glass wall 2 shattering, e.g. as a result of the container 1 being dropped, the retention function seeking to ensure that the coating 5 forms a sheath that retains both the broken glass and the fluid substance that was present within the container 1.

Preferably, the coating 5 also provides a reinforcement function for reinforcing the glass wall 2, in particular by filling in microcracks that might be present in the surface of the glass wall 2.

The protection and retention coating 5 is a multilayer coating, i.e. it is made up of at least two superposed layers. In the preferred embodiment shown, the coating 5 is made up of two layers. However, it is entirely possible for the coating 5 to comprise more than two layers, e.g. three or four layers, or more. Preferably, the coating 5 is also substantially transparent, so as to make it possible, in particular, to check the contents of the container 1 visually, in particular when the composition is a composition for pharmaceutical use, as in the preferred embodiment. This means that each of the various layers that make up the coating 5 is individually transparent, so that the resulting multilayer structure that forms the coating 5 is itself substantially transparent, or, at the least, transparent enough to make it possible to inspect the contents of the reception cavity 3 visually.

As shown in FIG. 1, the coating 5 includes a bottom layer 5A that covers the glass wall 2. In the preferred embodiment shown in FIG. 1, the bottom layer 5A covers the glass wall 2 directly, i.e. it comes into direct contact with the glass wall 2, and in particular with its outside face 21, without any intermediate layer being interposed between the bottom layer 5A and said glass wall 2 (and in particular the outside face 21 of said glass wall 2). In this configuration, the bottom layer 5A thus adheres to the outside face 21 of the glass wall 2 preferably by itself and directly (without any intermediate primer layer nor any layer of adhesive) and in particular it adheres to the outside face 21 of the glass wall 2.

The coating 5 also includes a top layer 5B that covers the bottom layer 5A, i.e. that is superposed on and against said bottom layer 5A such that said bottom layer 5A is interposed between firstly the glass wall 2 and secondly the top layer 5B. In the preferred embodiment shown in FIG. 1, the coating 5 is a bilayer coating, the bottom layer 5A bonding directly to the glass wall 2, while the top layer 5B forms the surface layer of the coating 5.

In accordance with the invention, the bottom layer 5A is made up of a polyurethane-based flexible material that bonds to the glass wall 2, preferably directly as described above. Advantageously, the flexible material in question is mainly made up of a polyurethane, and is preferably almost entirely made up of a polyurethane that is selected for its glass-bonding qualities, its flexible nature (that provides good shock absorption and protection against impacts), and for its mechanical strength that makes it possible to retain both the broken glass resulting from the glass wall 2 being shattered and the fluid substance contained in the container 1.

Preferably, the flexible material forming said bottom layer 5A is obtained by drying a first intermediate composition consisting of a dispersion of a non-reactive (i.e. entirely pre-polymerized) polymerized material (polyurethane) in an aqueous phase, the molecular mass of said non-reactive polymerized material being high enough (e.g. at least equal to 200,000 grams per mole (g·mol⁻¹), and in even more preferred manner at least equal to 300,000 g·mol⁻¹) for mere evaporation of the aqueous phase as a result of said drying to cause a film to form that constitutes the bottom layer 5A. In other words, the bottom layer 5A is preferably obtained exclusively by drying the first intermediate composition once said composition has been deposited in the form of a layer on the surface of the glass wall 2, advantageously without any reaction, and in particular without any polymerization or cross-linking reaction, taking place after said first intermediate composition has been deposited on the glass wall 2. Advantageously, the mere evaporation of the aqueous phase within which the polymerized material is dispersed, suffices to form a cohesive film that bonds directly to the outside face 21 of the glass wall 2, and that thus forms the bottom layer 5A. The first intermediate composition thus does not contain reactive compositions of the isocyanate type, but directly includes the polymer that has already been completely polymerized and dispersed in an aqueous phase. Preferably, said dispersion forming the first intermediate composition is an aqueous emulsion of the polymerized material, i.e. liquid or semi-liquid particles of said polyurethane-based polymer are dispersed in water, thereby making the application process easier, in particular by means of spray tools. However, the invention is not limited to using an aqueous emulsion, and, by way of example, it is entirely possible for the polymerized material to be in the form of a suspension of solid polymer particles in water, or even a solution of said polymer in water. Using a pre-polymerized polyurethane in an aqueous phase thus makes it easier to apply and to obtain the bottom layer 5A, and to also reduce the risks to operators, given that the phase is aqueous.

The top layer 5B is made up of a polyurethane-based material that is functionalized by a fluoropolymer-based compound, in particular so as to enable the surface of the coating to be sufficiently hydrophobic to enable the container 1 to be sterilized, and in particular to be sterilized in an autoclave.

Preferably, the fluoropolymer thus advantageously modifies the nature of one or more groups carried by the polymer chains of a polyurethane-based material so as to confer specific properties thereto.

The top layer 5B thus provides different functions and seeks in particular to protect the bottom layer 5A, to preserve the bonding of said bottom layer to the glass wall 2 (in particular by preventing water from reacting with the bottom layer 5A, thereby making it possible, in particular, to avoid the bottom layer 5A “swelling” under the effect of the water, which could lead to a loss of cohesion with the glass wall 2), and to make it possible for the container 1 coated in this way to be sterilized, including by using aggressive techniques such as sterilizing in an autoclave at 121° C., in compliance with the standards in force in the pharmaceutical field.

In particular, when the bottom layer 5A is obtained exclusively by drying a first intermediate composition consisting of a dispersion of a pre-polymerized material in an aqueous phase, without any subsequent polymerizing or cross-linking reaction, the cohesive film obtained presents an elastic and flexible nature that makes it possible to provide good protection against impacts and to retain effectively the shards of glass and the liquid in the event of the glass wall 2 being shattered.

A cross-linking additive of the silane type could be added to the first intermediate composition so as to cross-link the polymerized material after it has been deposited on the glass wall 2. That makes it possible to improve bonding, chemical resistance, and hydrolytic resistance. In contrast, such cross-linking also tends to make the film forming the bottom layer 5A brittle, which consequently degrades its retention properties significantly. In the preferred embodiment described above, the invention thus relies in particular on the idea of omitting post-deposit polymerization or cross-linking, and of compensating for the unfavorable effects of this absence of polymerization or cross-linking by using the top layer 5B to protect the bottom layer 5A, which may in particular be vulnerable to sterilization.

As a result of the material forming the top layer 5B being polyurethane based, the top layer 5B can bond effectively and naturally to the bottom layer 5A that is also polyurethane based. In addition to this compatibility between the bottom and top layers 5A, 5B, obtained by the common presence of polyurethane in the two layers 5A, 5B in question, the composition of the top layer 5B enables the container 1 to behave well during sterilization, and in particular during sterilization by autoclave. Specifically, the functionalization by a fluoropolymer, and in particular by a fluoropolymer that is polytetrafluoroethylene (PTFE), makes it possible to impart a hydrophobic nature to the surface of the coating 5, together with high resistance to blocking, and a particularly smooth nature. These various properties enable the coating 5 to be subjected to the stresses inherent to sterilizing operations, whether said operations be physical (in an autoclave at 121° C., or in boiling water, or by microwaves) or chemical (cold chemical sterilization). When a plurality of bottles that are arranged side-by-side and in contact with one another are sterilized simultaneously, the resistance to blocking makes it possible, in particular, to avoid the containers accidentally bonding to one another under the effect of the physico-chemical stresses induced by sterilization.

Preferably, said material forming the top layer 5B includes the reaction product of an isocyanate and at least one fluoropolymer-based substance. More precisely, the top layer 5B is advantageously obtained by polymerizing a second intermediate composition in an aqueous phase, which composition includes at least said isocyanate and said fluoropolymer-based substance, and naturally other components might also be present (such as alcohol for reacting with the isocyanate and for forming polyurethane). The second intermediate composition is thus deposited on the bottom layer 5A, then its components react together so as to form a polyurethane-based polymer that is functionalized by a fluoropolymer, which is preferably polytetrafluoroethylene (PTFE). The use of PTFE makes it possible to obtain a top layer 5B with excellent resistance to blocking, while using a polyurethane-precursor isocyanate makes it possible to ensure that the surface layer, formed specifically by the top layer 5B, is compatible with and bonds to the polyurethane-based under-layer (bottom layer 5A). The second intermediate composition thus advantageously constitutes a protective varnish in an aqueous phase that, once applied to the under-layer made up of the bottom layer 5A, reacts so as to form a polyurethane-based polymer that is functionalized by a fluoropolymer, making it possible to obtain a homogeneous and continuous smooth layer on the surface of the coating 5, with excellent resistance to blocking, that allows the container 1 to be sterilized without significantly or permanently degrading the coating 5.

Advantageously, said isocyanate is an isocyanate that is blocked, preferably by means of a suitable blocking agent (e.g. a blocking agent that enables the blocked isocyanate to be soluble in water). In particular, this makes it easy to preserve the second intermediate composition and to store it over time, while enabling the isocyanate in question to remain reactive and to polymerize when the required conditions are met (e.g. when the temperature is high enough). Preferably, the second intermediate composition is exempt of any free isocyanate and only includes one or more blocked isocyanates.

Said bottom layer 5A and said top layer 5B preferably have compositions that are different, i.e. the materials respectively forming the bottom layer 5A and the top layer 5B are not strictly identical from the point of view of their chemical compositions and/or of their structures. In particular, whereas the top layer 5B is formed by a polyurethane-based material functionalized by a fluoropolymer-based compound, as described above, said bottom layer 5A is advantageously free from any fluorinated compound. More specifically, the polyurethane-based material forming the bottom layer 5A is preferably not functionalized by a fluoropolymer-based compound. Compatibility between said bottom layer 5A and said top layer 5B is thereby further improved, it thus being possible for the top layer 5B to adhere perfectly to the bottom layer 5A, thereby significantly limiting any risk of said bottom layer 5A and said top layer 5B delaminating or separating.

In particular, in its advantageous embodiment described above and shown in FIG. 1, the invention thus makes it possible to obtain a container 1 that is particularly suitable for pharmaceutical use (since it is able to withstand the stresses of sterilization), while being particularly able to withstand impacts, and presenting a remarkable ability to retain broken glass and liquid.

Advantageously, the thickness of the bottom layer 5A is greater than the thickness of the top layer 5B. Specifically, the bottom layer 5A is particularly for absorbing shocks and for providing a function of retaining any broken glass and fluid, these different functions requiring the bottom layer 5A to be thick enough. Conversely, the top layer 5B serves above all to provide protection for the bottom layer 5A, and, as a result, it may thus be thinner.

Preferably, the thickness E1 of said bottom layer 5A lies substantially in the range 30 micrometers (μm) to 300 μm. In a particularly advantageous embodiment, the thickness E1 of said bottom layer 5A lies substantially in the range 50 μm to 200 μm, and in even more preferred manner it is substantially equal to 100 μm. The above-mentioned thickness ranges, which may naturally be adapted as a function of the nature of the container 1 to be coated, and in particular as a function of the size and of the weight of said container, make it possible to obtain good protection against impacts, and to guarantee sufficient mechanical strength for the bottom layer 5A, so as to ensure that any broken glass and/or fluid compositions are retained.

Advantageously, the thickness E2 of said top layer 5B lies substantially in the range 5 μm to 50 μm, and in even more preferred manner lies substantially in the range 10 μm to 30 μm, and preferably it is substantially equal to 20 μm. By way of example, for a bottle having a capacity of 100 milliliters (mL) and weight equal to 89 grams (g), a thickness E1 of the bottom layer 5A that is advantageously equal to substantially 100 μm makes it possible to obtain good results with regard to protection against impacts and to retention.

The invention also relates specifically to a kit for manufacturing a multilayer protection and retention coating 5 that is substantially transparent, said coating 5 preferably being in accordance with the above description, and thus being for covering at least a fraction of the outside of a glass wall 2 of a container 1, which glass wall defines a reception cavity 3 for receiving a fluid substance, in accordance with the above description.

The kit of the invention comprises:

a first intermediate composition for applying in the form of a first layer to the glass wall 2, said first intermediate composition advantageously consisting of a dispersion of a non-reactive polyurethane in an aqueous phase, the molecular mass of said non-reactive polyurethane being high enough for mere evaporation of the aqueous phase to cause a flexible film that bonds to the glass wall 2 to be formed from said first layer; and

a second intermediate composition in an aqueous phase for applying in the form of a second layer covering said first layer, said second intermediate composition in an aqueous phase including at least one isocyanate (preferably blocked) and at least one fluoropolymer-based substance (preferably polytetrafluoroethylene (PTFE)) for reacting together after applying said second intermediate composition to said first layer, so as to form a polyurethane-based material that is functionalized by a fluoropolymer-based compound.

Advantageously, said above-mentioned first and second intermediate compositions are in accordance with the detailed description set out above in relation to the container 1 of the invention, such that said description also applies in full to the kit of the invention.

In this respect, said first and second intermediate compositions are preferably of different compositions, i.e. their chemical formulations are not strictly identical, despite said first and second intermediate compositions both being for forming layers of a polyurethane-based material. In particular, whereas said second intermediate composition includes a fluoropolymer-based substance, as described above, said first intermediate composition is advantageously free from any fluorinated compound. More specifically, said first intermediate composition advantageously does not include any fluoropolymer-based substance, such that said flexible film obtained by implementing said first intermediate composition is made up of a polyurethane-based material that is preferably not functionalized by a fluoropolymer-based compound.

In still another aspect, the invention provides a method of manufacturing a container 1, in which method a glass wall 2 defining a reception cavity 3 for receiving a fluid substance is manufactured or provided. The method in question is advantageously a method of manufacturing a container 1 of the invention, such that the description set out above in relation to the container 1 of the invention remains valid and applicable, mutatis mutandis, to the present method. The present method includes a step of covering at least a fraction of the outside of the glass wall 2 with a protection and retention coating 5. As described above, the protection and retention coating 5 is a multilayer coating that is substantially transparent and that comprises a bottom layer 5A that covers the glass wall 2, and a top layer 5B that covers said bottom layer 5A, said bottom layer 5A being made up of a flexible polyurethane-based material that bonds to the glass wall 2, while the top layer 5B is made up of a polyurethane-based material that is functionalized by a fluoropolymer-based compound, in particular so as to enable the surface of the coating to be sufficiently hydrophobic to enable the container 1 to be sterilized, and in particular to be sterilized in an autoclave.

During said covering step, said bottom layer 5A preferably covers the glass wall 2 directly without any intermediate layer between said glass wall 2 and said bottom layer 5A. The bottom layer 5A thus comes directly into contact with the glass wall 2, and in particular it comes into direct contact with its outside face 21 without any intermediate layer being interposed between the bottom layer 5A and said glass wall 2. The bottom layer 5A thus advantageously adheres to the outside face 21 of the glass wall 2 preferably by itself and directly (without any intermediate primer layer nor any layer of adhesive).

In addition, and as explained above, said bottom layer 5A and top layer 5B of the coating 5 that is caused to cover at least a fraction of the glass wall 2 of the container 1 during the covering step are layers of compositions that are different, i.e. the materials respectively forming the bottom layer 5A and the top layer 5B are not strictly identical from the point of view of their chemical compositions and/or their structures. In particular, whereas the top layer 5B is formed by a polyurethane-based material functionalized by a fluoropolymer-based compound, as described above, said bottom layer 5A is advantageously free from any fluorinated compound. More specifically, the polyurethane-based material forming the bottom layer 5A is preferably not functionalized by a fluoropolymer-based compound. Advantageously, this makes it possible to further improve the compatibility between said bottom layer 5A and top layer 5B, with it then being possible for the top layer 5B to adhere perfectly to the bottom layer 5A, thereby significantly limiting any risk of said bottom layer 5A and said top layer 5B delaminating or separating.

Advantageously, said covering step itself includes a step of forming the bottom layer 5A, during which:

a first intermediate composition consisting of a dispersion of a non-reactive polymerized material in an aqueous phase is applied, e.g. by spraying, to the glass wall 2 in the form of a first layer. The first intermediate composition, that is advantageously in accordance with the description set out above in relation to the container 1 of the invention, may be deposited on the glass wall 2 while said glass wall 2 is at ambient temperature, or, on the contrary, after it has been subjected to pre-heating such that its temperature is greater than ambient temperature. Preferably, the glass wall 2 is subjected to corona or plasma treatment before applying the first intermediate composition, so as to improve wettability and bonding. By way of example, the first intermediate composition may be applied by an electrostatic spray technique using a bowl or a disk, which technique turns out to be particularly advantageous in terms of cost and industrialization, but spray gun application could also be entirely suitable, it being understood that the invention is not limited in any way to a particular technique used for application.

the first intermediate composition applied to the glass wall 2 in this way, preferably in the form of a first continuous and uniform homogeneous layer, is then dried, e.g. in still air or in forced manner (by applying heat and/or by blowing), so as to cause the aqueous phase to evaporate (desolvation operation, that may be performed after the second layer has been deposited as described below), the molecular mass of said polymerized material being high enough for mere evaporation of the aqueous phase as a result of said drying to cause a film to form that constitutes the bottom layer 5A, as described above.

As set out above in relation to the description of the container 1 of the invention, the polymerized material dispersed in an aqueous phase in order to form the first intermediate composition has already reacted and is thus no longer reactive, i.e. it is already polymerized, and, after applying the first intermediate composition to the glass wall 2, it is not subjected to any subsequent reaction, in particular polymerization or cross-linking.

Preferably, the flexible and cohesive film forming the bottom layer 5A is thus obtained solely by the aqueous phase of the first intermediate composition evaporating, without any subsequent polymerization or cross-linking reaction taking place after the first intermediate composition has been applied to the glass wall 2, thereby making it possible to obtain a sheath that is flexible enough to provide good shock-absorption and effective retention of broken glass and liquid, possibly to the detriment of properties of resistance to chemical compositions and water, and thus to sterilization. However, as described above, this vulnerability is overcome by means of the top layer 5B, for which preferred methods of formation are described below.

Preferably, the dispersion in an aqueous phase forming the first intermediate composition is an aqueous emulsion of said polymerized material, such that liquid or semi-liquid particles of said polymerized material are dispersed in an aqueous phase. However, as stated above, the invention is not limited to using an emulsion, and it is entirely possible for the dispersion in question to consist of a suspension or a solution, for example. However, the use of an emulsion turns out to be advantageous in terms of industrialization and of the technique used for applying the first intermediate composition, in particular by spraying.

Advantageously, the first intermediate composition presents viscosity at 20° C. that lies substantially in the range 800 millipascal seconds (mPa·s) to 2000 mPa·s, preferably substantially in the range 1000 mPa·s to 1800 mPa·s, thereby making it possible to apply the first intermediate composition easily to the glass wall 2 in a homogeneous and uniform thin layer, in particular by means of spray instruments, as described above. To this end, it is particularly advantageous for the first intermediate composition to present viscosity at 20° C. that lies substantially in the range 1300 mPa·s to 1400 mPa·s.

Advantageously, the first intermediate composition presents a solids content that lies in the range 20% to 70% by weight, preferably in the range 30% to 60% by weight, and in even more preferred manner in the range 45% to 55% by weight, so as to make it possible, merely by evaporating the aqueous phase, to obtain a homogeneous and cohesive film for forming the bottom layer 5A and for bonding directly to the glass wall 2 for this purpose. In a particularly preferred embodiment, the first intermediate composition presents a solids content that is equal to 48% by weight.

Preferably, the first intermediate composition is deposited on the surface of the glass wall 2 in the form of a first layer having a thickness that is selected such that, once the first intermediate composition has dried and the aqueous phase has evaporated, the thickness of the resulting bottom layer 5A lies substantially in the range 30 μm to 300 μm, preferably in the range 50 μm to 200 μm, and in even more preferred manner it is substantially equal to 100 μm, as described above in relation to the description of the container 1 of the invention.

Advantageously, in order to protect the bottom layer 5A, the above-mentioned covering step also includes a step of forming the top layer 5B, during which:

A second intermediate composition in an aqueous phase, the composition including at least one isocyanate (that is preferably a blocked isocyanate for the reasons set out above) and at least one fluoropolymer-based substance (that is preferably polytetrafluoroethylene (PTFE) for the reasons also set out above) is applied to said first layer, e.g. immediately after applying said first layer, while said first layer is still wet, or after a waiting time (e.g. of several tens of minutes), so as to apply the second intermediate composition to the first layer when dry. As explained above, said second intermediate composition is preferably different from said first intermediate composition, i.e. the respective chemical formulations of said first and second intermediate compositions are not strictly identical, said first intermediate composition advantageously being free from any fluorinated compound. The second intermediate composition is advantageously applied to the first layer by means similar to the means used for applying the first intermediate composition, e.g. by spraying, and in particular by electrostatic spraying using a bowl or a disk (so long as the second layer is applied to the still-wet first layer (wet-on-wet application), i.e. still containing enough water to enable the electrostatic method to function properly), an application by spray gun may be preferred (in particular when the second layer is applied after the first layer has dried completely, which first layer is thus already entirely desolvated and forms the bottom layer 5A).

Said second intermediate composition as applied in this way, preferably in the form of a uniform and homogeneous thin layer, to the (wet or dry) first layer is then subjected to treatment that causes at least said isocyanate to react with the fluoropolymer-based substance so as to form said polyurethane-based material that is functionalized by a fluoropolymer-based compound (advantageously PTFE).

In other words, once the second intermediate composition has been applied to the first layer, a polymerizing reaction occurs within said second intermediate composition that causes the isocyanate and fluoropolymer mixture to transform into a polyurethane that is functionalized by a fluoropolymer-based compound.

By way of example, the reaction may occur spontaneously as a result of exposing a thin layer of second intermediate composition to the surrounding air, in which event the treatment in question consists merely in exposing the second intermediate composition that has been applied to the first layer to the air, so that it reacts spontaneously. Alternatively, and in a preferred implementation of the invention, the treatment that causes the above-mentioned reaction is rather heat treatment that enables a threshold temperature to be reached, from which the isocyanate polymerizes and reacts with the fluoropolymer. By way of example, the treatment includes a step of curing the container 1 to which said second intermediate composition has been applied, at a temperature that is high enough to trigger the above-mentioned reaction, said temperature lying substantially in the range 90° C. to 200° C., for example, preferably in the range 120° C. to 180° C., and in even more preferred manner in the range 142° C. to 170° C. The curing step may be performed in a traditional hot-air oven, or by any other means (infrared heating The curing step thus makes it possible to obtain a surface layer that is smooth, with excellent resistance to blocking, and with a hydrophobic nature, making it possible to sterilize the container 1, including in an autoclave.

Preferably, before proceeding to the curing step that causes the above-mentioned reaction to take place within said second intermediate composition, a desolvation step is performed, in particular when the second intermediate composition has been applied to the still-wet first intermediate composition, so as to dry both the second layer and (above all) the first layer in this way. By way of example, this operation may last several tens of minutes, in particular when it is performed in the surrounding air, which duration may be shortened by stirring the surrounding air and/or by raising the ambient temperature (but to less than 100° C.) However, before applying the second layer, it is entirely possible to desolvate the first layer (e.g. for 15 minutes (min) to 30 min as a function of the temperature and air-stirring conditions). Once the second layer has been deposited, said second layer is then desolvated (e.g. for 5 min to 10 min as a function of the temperature and air-stirring conditions), then curing takes place so as to initiate the above-mentioned polymerizing reaction.

Advantageously, said second intermediate composition presents viscosity at 20° C. that lies substantially in the range 5 mPa·s to 30 mPa·s, preferably substantially in the range 10 mPa·s to 20 mPa·s, so as to make it easier to apply, in particular by spraying, and so as to make it easy to cover the first layer in homogeneous and uniform manner.

To this end, the viscosity at 20° C. of the second intermediate composition even more preferably lies substantially in the range 14 mPa·s to 15 mPa·s.

Advantageously, the second intermediate composition presents a solids content that lies in the range 10% to 60% by weight, preferably in the range 20% to 50% by weight, and in even more preferred manner in the range 25% to 40% by weight. By way of example, a solids content that is equal to 32% by weight leads to excellent results, both in terms of industrialization and in terms of the properties of the coating 5 obtained.

Advantageously, the second intermediate composition is applied to the first layer in such a manner that the thickness of the top layer 5B that it causes to be obtained lies substantially in the range 5 μm to 50 μm, preferably lies substantially in the range 10 μm to 30 μm, and in even more preferred manner it is substantially equal to 20 μm, so as to protect the under-layer (bottom layer 5A) effectively, but without constituting excess thickness that is unnecessary or awkward.

Finally, the use of a multilayer coating 5, and in particular a bilayer coating 5 with an under-layer having an essentially mechanical function (shock absorption, retention), covered by a protective varnish (surface layer) presenting very good resistance to blocking and a smooth and hydrophobic nature, that is formed directly on the glass wall 2 of the container 1 and that bonds directly thereto, makes it possible, in simple and industrializable manner, to obtain a container 1 that is entirely suitable for pharmaceutical use, in particular for containing cytotoxic liquid compositions (e.g. anticancer drugs).

The examples and test results set out below make it possible to better understand the practical contribution of the invention. The tests were conducted using 100 mL glass bottles comprising a first series of twenty bottles that were covered by a protection and retention coating 5 in accordance with the invention, and another series of identical bottles (likewise twenty 100 mL bottles) that remained without a coating. The bottles that formed part of the series of bottles of the invention are referred to below as “plasticized bottles”, while the simple glass bottles without any coating are referred to as “non-plasticized bottles”.

The coating of the plasticized bottles was a bilayer coating with a bottom layer 5A having thickness substantially equal to 100 μm, while the top layer 5B presented thickness substantially equal to 30 μm. The bottom layer 5A was made up of a polyurethane that bonded directly to the glass wall 2, and was obtained by drying a first intermediate composition that consisted of an aqueous emulsion of a completely pre-polymerized polyurethane-based material, with a solids content substantially equal to 48% by weight, that included 3% to 10% by weight of co-solvent, preferably 5% by weight of co-solvent, and that had viscosity at 20° C. that preferably lay in the range 1300 mPa·s. to 1400 mPa·s. Specifically, the surface layer (top layer 5B) was obtained by curing a second intermediate composition in an aqueous phase that was applied in the form of a second layer that covered the first layer for forming the bottom layer 5A, the second intermediate composition in an aqueous phase included a blocked isocyanate and PTFE, and possibly other compounds (alcohol for reacting together under the effect of temperature, and, specifically, under the effect of heating to a temperature that lay in the range 142° C. to 170° C. so as to obtain, by polymerization, a PTFE-functionalized polyurethane-based varnish. The second intermediate composition in an aqueous phase presented a solids content substantially equal to 32% by weight, and viscosity of about 14 mPa·s to 15 mPa·s at 20° C.

The two above-mentioned series of plasticized and non-plasticized bottles were initially subjected to drop tests, performed on a test bench on which each bottle was positioned vertically and guided to drop onto a stainless steel plate, through a drop height equal 1.5 meters (m). Each bottle that was subjected to the drop test was filled to 80% of its brim capacity. The results of the drop tests were as follows: 40% (i.e. eight out of twenty bottles) of the plasticized bottles shattered, while 75% (i.e. fifteen out of twenty bottles) of the non-plasticized bottles shattered). The breakage percentage was thus much higher for the non-plasticized bottles, which confirms that the coating 5 contributes to reinforcing the glass wall 2, in particular it would appear by filling the microcracks present in the surface.

The above-mentioned drop tests also made it possible to observe that when a bottle shattered, and when it was not plasticized, it always burst. In contrast, when it was plasticized in accordance with the invention, the broken glass was always retained and the bottle kept its integrity. With a coating that is thick enough, the liquid is also retained.

Specifically, the results with regard to retention were as follows: out of the eight bottles that shattered, seven retained both the broken glass and the liquid, while only one retained the broken glass only.

Finally, various tests for sterilizing bottles coated in accordance with the invention were performed, and made it possible to conclude that the containers of the invention can accommodate the main types of sterilization, as set out below in Table 1.

TABLE 1

| Sterilization | Conditions | Observations |
|---|---|---|
| Autoclave | 30 min | Slight flattening |
| | 121° C. | observed at the |
| | 2 bars | contact zones where |
| | Presence of steam | bottles touched, as |
| | | a result of the PU |
| | | softening at a |
| | | temperature of |
| | | 121° C. |
| Electric | 5 min in an electric | Significant |
| sterilizer | sterilizer for baby | whitening that |
| | bottles (steam) | disappeared after a |
| Microwaves | 4 min at 850 watts | few minutes at |
| | (W) in a microwave | ambient temperature |
| | sterilizer for baby | |
| | bottles (steam) | |
| Cold chemical | 30 min in a sodium | No modification/ |
| | hypochlorite | degradation of the |
| | solution | coating was |
| | | observed |

A coating 5 is described above that presents a visual appearance that is homogeneous. However, by way of example, it is entirely possible to introduce pigments into the bottom layer 5A and/or into the top layer 5B, so as to obtain a colored coating that is translucent to a greater or lesser extent, or so as to obtain protection against ultraviolet (UV) light. Various effects and textures may also be sought and obtained, e.g. by including particles or flakes. The coating 5 of the invention also lends itself to applying a decoration to its top layer 5B, e.g. by silk-screen printing or any other known technique.

Finally, the idea of having recourse to a simple dispersion of a pre-polymerized polyurethane in an aqueous phase (thereby making the use of catalysts pointless), with the molecular mass of said pre-polymerized polyurethane being high enough for mere evaporation of the aqueous phase to cause a flexible and cohesive film to form that bonds to the glass wall 2, constitutes an invention as such.

Under such circumstances, an independent invention as such is constituted by a container comprising a glass wall defining a reception cavity for receiving a liquid substance, said container further comprising a protection and retention coating that covers at least a fraction of the outside of said glass wall, said protection and retention coating being a multilayer coating that firstly comprises a bottom layer that is obtained by drying a first intermediate composition consisting of a dispersion of a (non-reactive) pre-polymerized polyurethane-based material in an aqueous phase, the molecular mass of said material being high enough for mere evaporation of the aqueous phase as a result of said drying to cause a film to form that constitutes said bottom layer, and secondly a top layer (with or without fluoropolymer) that covers said bottom layer so as to protect it.

1. A container (1) comprising a glass wall (2) defining a reception cavity (3) for receiving a fluid substance, said container (1) further comprising a protection and retention coating (5) that covers at least a fraction of the outside of said glass wall (2), said container (1) being characterized in that said protection and retention coating (5) is a multilayer coating that is substantially transparent and that comprises a bottom layer (5A) that covers the glass wall (2), and a top layer (5B) that covers said bottom layer (5A), said bottom layer (5A) being made up of a polyurethane-based flexible material that bonds to said glass wall (2), while said top layer (5B) is made up of a polyurethane-based material that is functionalized by a fluoropolymer-based compound.

2. A container (1) according to claim 1, characterized in that said bottom layer (5A) covers the glass wall (2) directly, without any intermediate layer between said glass wall (2) and said bottom layer (5A).

3. A container (1) according to claim 1, characterized in that said bottom layer (5A) and said top layer (5B) are of different compositions.

4. A container (1) according to claim 3, characterized in that said bottom layer (5A) is free from any fluorinated compound.

5. A container (1) according to claim 1, characterized in that the thickness (E1) of said bottom layer (5A) is greater than the thickness (E2) of the top layer (5B).

6. A container (1) according to claim 1, characterized in that the thickness (E1) of said bottom layer (5A) lies substantially in the range 30 μm to 300 μm.

7. A container according to claim 6, characterized in that the thickness) of said bottom layer (5A) lies substantially in the range 50 μm to 200 μm, and preferably is substantially equal to 100 μm.

8. A container (1) according to claim 1, characterized in that the thickness (E2) of said top, layer (5B) lies substantially in the range 5 μm to 50 μm.

9. A container (1) accord to claim 8, characterized in that the thickness (E2) of said top layer (5B) lies substantially in the range 10 30 μm, and preferably it is substantially equal to 20 μm.

10. A container (1) according to claim 1, characterized in that said coating (5) is a bilayer coating, the bottom layer (5A) bonding directly to the glass wall (2), while the top layer (5B) forms the surface layer of the coating (5).

11. A container (1) according to claim 1, characterized in that said flexible material forming the bottom layer (5A) is obtained by drying a first intermediate composition consisting of a dispersion of a non-reactive polymerized material in an aqueous phase, the molecular mass of said non-reactive polymerized material being high enough for mere evaporation of the aqueous phase as a result of said drying to cause a film to form that constitutes said bottom layer (5A).

12. A container (1) according to claim 11, characterized in that said dispersion is an aqueous emulsion of said polymerized material.

13. A container (1) according to claim 1, characterized in that said fluoropolymer is polytetrafluoroethylene (PTFE).

14. A container (1) according to claim 1, characterized in that said material forming the top layer (5B) includes the reaction product of an isocyanate and at least one fluoropolymer-based substance.

15. A container (1) according to claim 14, characterized in that said material forming the top layer is obtained by polymerizing a second intermediate composition in an aqueous phase, which composition includes at least said isocyanate and said fluoropolymer-based substance.

16. A container (1) according to claim 14, characterized in that said isocyanate is a blocked isocyanate.

17. A container (1) according to claim 1, characterized in that it forms a container that is designed for containing a liquid substance for pharmaceutical use.

18. A kit for manufacturing a multilayer protection and retention coating (5) that is substantially transparent and that is for covering at least a fraction of the outside of a glass wall (2) of a container (1), said glass wall (2) defining a reception cavity (3) for receiving a fluid substance, said kit comprising:
a first intermediate composition for applying in the form of a first layer to the glass wall (2), said first intermediate composition consisting of a dispersion of a non-reactive polyurethane in an aqueous phase, the molecular mass of said non-reactive polyurethane being high enough for mere evaporation of the aqueous phase to cause a flexible film that bonds to the glass wall (2) to be formed from said first layer; and
a second intermediate composition in an aqueous phase for applying in the form of a second layer covering said first layer, said second intermediate composition in an aqueous phase including at least one isocyanate and at least one fluoropolymer-based substance for reacting together after applying said second intermediate composition to said first layer, so as to form a polyurethane-based material that is functionalized by a fluoropolymer-based compound.

19. A method of manufacturing a container (1), in which method a glass wall (2) defining a reception cavity (3) for receiving a fluid substance is manufactured or provided, said method including a step of covering at least a fraction of the outside of said glass wall (2) with a protection and retention coating (5), said method being characterized in that said protection and retention coating (5) is a multilayer coating that is substantially transparent and that comprises a bottom layer (5A) that covers the glass wall (2), and a top layer (5B) that covers said bottom layer (5A), said bottom layer (5A) being made up of a polyurethane-based flexible material that bonds to said glass wall (2), while said top layer (5B) is made up of a polyurethane-based material that is functionalized by a fluoropolymer-based compound.
